(19) United States
(12) Patent Application Publication
(10) Pub. No.: US 2009/0072675 A1
(43) Pub. Date: Mar. 19, 2009

(54) PULSE MOTOR

(75) Inventor: Toshihiro Kanehara, Tokyo (JP)

Correspondence Address: SUGHRUE-265550, 2100 PENNSYLVANIA AVE. NW, WASHINGTON, DC, 20037-3213, US

(73) Assignee: YOKOGAWA ELECTRIC CORPORATION, Musashino-shi (JP)

(21) Appl. No.: 11/914,558

(22) PCT Filed: May 16, 2006
(86) PCT No.: PCT/JP2006/309760

§ 371 Date: Jan. 9, 2008

(30) Foreign Application Priority Data
May 17, 2005 (JP) 2005-143909
Nov. 8, 2005 (JP) 2005-323165

(51) Int. Cl. H02K 37/02

(52) U.S. Cl. 310/49 R

(57) ABSTRACT

A pulse motor includes: a first iron core having a plurality of iron core teeth; a second iron core having a plurality of iron core teeth, the second iron core being arranged to oppose to the first iron core through an air gap; and commutating pole teeth formed between the iron core teeth; wherein a level difference is provided between a tooth tip of the iron core tooth and a tooth tip of the commutating pole tooth

### TECHNICAL FIELD

The present invention relates to a pulse motor in which a first iron core having a plurality of iron core teeth and a second iron core having a plurality of iron core teeth are arranged to oppose to each other via an air gap.

### BACKGROUND ART

FIG. 7A and FIG. 7B are a front sectional view showing a configurative example of a pulse motor to which no inter-tooth permanent magnet is provided respectively. FIG. 7A shows magnetic flux paths when a magnetomotive force is small, and FIG. 7B shows the magnetic flux paths when the magnetomotive force is large. FIG. 8 is a side sectional view showing the same pulse motor. Reference numerals 1a, 1b denote a pair of first iron cores that are arranged in parallel to put a bias permanent magnet 2 therebetween.

A reference numeral 3 denotes an exciting coil that is wound around the first iron cores 11, 1b in such a way that the bias permanent magnet 2 is positioned in its center portion. A reference numeral 4 denotes a second iron core that is arranged to oppose the first iron cores 1a, 1b via an appropriate air gap G.

Here, it is defined that φc is a coil magnetic flux generated when a drive current I is given to the exciting coil in the illustrated direction and φm is a magnetic flux of the bias permanent magnet 2 when its polarity is given as illustrated. Since both magnetic fluxes are added mutually on the first iron core 1a side and both magnetic fluxes are subtracted mutually on the first iron core 1b side, a main magnetic flux φ that circulates through the first iron cores 1a, 1b and the second iron core 4 is given by

Main magnetic flux φ=(magnetic flux φm of the bias permanent magnet)±(coil magnetic flux φc).

FIG. 9 is a characteristic view showing a relationship between the magnetomotive force nI (n is the number of turns and I is the drive current) and a magnetic flux density B. This relationship shows a saturation characteristic. The bias permanent magnet 2 shifts an operating point to a P point at which an adequate bias is given to the magnetomotive force nl and a change of the magnetic flux is within a linear range.

A reference numeral C1 denotes iron core teeth that are formed on portions of the first iron cores 1a, 1b opposite to the second iron core 4 at an appropriate pitch. A reference numeral C3 denotes iron core teeth that are formed on the portion of the second iron core 4 opposite to the first iron cores 1 at the same pitch as that of the iron core teeth C1 on the first iron cores 1 side.

In such configuration, the magnetic flux paths on the first iron cores 1a side in the case where the drive current I applied to the exciting coil 3 is small and the magnetomotive force is small will be explained with reference to FIG. 7A hereunder. That is, the main magnetic flux φ(φc+φm) takes the route that passes through the iron core teeth C1 and then passes through the iron core teeth C3, which oppose to the iron core teeth C1 via the air gap and are shifted from the iron core teeth C1 to have a predetermined pitch, on the second iron core side. Here, φr1 denotes a leakage flux of the main magnetic flux φ generated between the iron core teeth C1 and the iron core teeth C3.

FIG. 10A and FIG. 10B are a front sectional view showing a configurative example of the pulse motor disclosed in Patent Document 1 and having the inter-tooth permanent magnets respectively. FIG. 10A shows magnetic flux paths when the magnetomotive force is small, and FIG. 10B shows the magnetic flux paths when the magnetomotive force is large. The same reference symbols are given to the same elements as those in FIG. 7A, FIG. 7B, and FIG. 8, and their explanation will be omitted herein. FIG. 11 is an enlarged view showing a pertinent portion in FIG. 10B.

A reference numeral C2 denotes commutating pole teeth that are formed in an intermediate portion between the iron core tooth C1 and the adjacent iron core tooth C1 respectively. The commutating pole teeth have a same height as the iron core teeth C1. A reference numeral 5 denotes inter-tooth permanent magnets that are inserted in space between the commutating pole tooth C2 and the adjacent iron core tooth C1 in a paired fashion respectively. These inter-tooth permanent magnets 5 are magnetized in the arranging direction of the iron core teeth C1, i.e., the direction perpendicular to the direction of the magnetic flux φ, and also magnetized alternately in the opposite direction in order of arrangement.

These inter-tooth permanent magnets 5 are designed to have the same height as the iron core teeth C1 and the commutating pole teeth C2. Thus, the iron core teeth C1, the commutating pole teeth C2, and the inter-tooth permanent magnets 5 constitute a flat opposing surface to the second iron core 4. Since a function of the inter-tooth permanent magnet has been disclosed in Patent Document 1, its explanation will be omitted herein.

In such configuration, the magnetic flux paths on the first iron cores 1a side in the case where the drive current I applied to the exciting coil 3 is small and the magnetomotive force is small will be explained with reference to FIG. 10A hereunder. That is, the main magnetic flux φ (φc+φm) takes the route that passes through a pair of inter-tooth permanent magnets 5 that put the commutating pole tooth C2 therebetween, then passes through the iron core teeth C1 opposing to the iron core teeth C1, and then passes through the iron core teeth C3 opposed via the air gap on the second iron core 4 side.

The reference numeral φr1 denotes the leakage flux of the main magnetic flux φ generated between the iron core teeth C1 on the first iron cores 1 side and the iron core teeth C3 on the second iron core 4 side. A reference numeral φs denotes an inter-tooth permanent magnet magnetic flux. Since a height of the commutating pole teeth C2 is equal to a height of the iron core teeth C1, this inter-tooth permanent magnet magnetic flux φs passes through the iron core teeth C3 opposed via the air gap on the second iron core 4 side. A reference numeral φq denotes a magnet leakage flux. Also, since a height of the commutating pole teeth C2 is equal to a height of the iron core teeth C1, this inter-tooth permanent magnet leakage flux φq passes across the iron core teeth C1 opposing to the commutating pole teeth C2 via the air gap.

The related-art relating to the pulse motor that has the commutating pole teeth of the first iron core or the second iron core formed between the iron core teeth and the inter-tooth permanent magnets inserted in space between the iron core teeth is shown in Patent Document 1: JP-A-6-225511, for example.

### DISCLOSURE OF THE INVENTION

### PROBLEMS THAT THE INVENTION IS TO SOLVE

In FIG. 7A and FIG. 7B showing the configuration of the pulse motor that has no inter-tooth permanent magnet, the magnetic flux paths on the first iron cores 1a side in the case where the drive current I applied to the exciting coil 3 is large and the magnetomotive force is large will be explained with reference to FIG. 7B hereunder.

Similarly to FIG. 7A, a main portion of the main magnetic flux φ (φc+φm) takes the route that passes through the iron core teeth C1 and then passes through the iron core teeth C3, which oppose to the iron core teeth C1 via the air gap and are shifted from the iron core teeth C1 to have a predetermined pitch, on the second iron core 4 side.

In addition to the leakage flux φr1 of the main magnetic flux φ generated between the iron core teeth C1 and the iron core teeth C3, a leakage flux φr2 is generated newly on the tooth-valleys between the iron core teeth C1 and the iron core teeth C3 and between the above tooth-valleys and tooth-valleys between the iron core teeth C3 of the second iron core 4.

Then, in FIG. 10A and FIG. 10B showing the configuration of the pulse motor that has the commutating pole teeth and the inter-tooth permanent magnets, the magnetic flux paths on the first iron cores 1a side in the case where the drive current I applied to the exciting coil 3 is large and the magnetomotive force is large will be explained with reference to FIG. 11 hereunder.

Similarly to FIG. 10A, a main portion of the main magnetic flux φ (φc+φm) takes the route that passes through the inter-tooth permanent magnets 5 that put the commutating pole tooth C2 therebetween, then passes through the iron core teeth C1 opposing to the commutating pole teeth C2, and then passes through the iron core teeth C3, which opposed via the air gap and are shifted from the iron core teeth C1 by a predetermined pitch, on the second iron core 4 side.

In FIG. 11, in addition to the main portion of the main magnetic flux paths, the magnetic flux passed from the iron core tooth C1 to the iron core tooth C3 and the main magnetic flux φ passed from the commutating pole tooth C2 to the iron core tooth C3 are generated newly. According to this, the leakage flux φr2 passed from the commutating pole tooth C2 to the iron core tooth C3 is generated newly from the main magnetic flux φ.

A relative generated thrust force F generated between the first iron core 1 and the second iron core 4 depends on a magnetic attracting force caused by the main magnetic flux φ, which passes through the iron core tooth C1 on the first iron core 1 side and the iron core tooth C3 on the second iron core 4 side, and an amount of change of the main magnetic flux with respect to time dφ/dt. In the configuration in the related-art, following problems exist in the request for improvement in the thrust force.

(1) In FIG. 7B, the main magnetic flux passing from the iron core tooth C1 to the iron core tooth C3 and the leakage flux φr1 contributes to the thrust force, and thus these magnetic fluxes cause no problem. However, the leakage flux φr2 is newly generated between the tooth-valleys between the iron core teeth C1 and the iron core teeth C3; and between the above tooth-valleys and tooth-valleys between the iron core teeth C3 of the second iron core 4. An amount of the main magnetic flux is reduced due to generation of the leakage flux φr2. These leakage fluxes act as a factor of preventing improvement of the generated thrust force according to the increase of the drive current I (the leakage flux φr2 is increased from portions other than the iron core teeth C1 in accordance with the increase of the magnetomotive force).

(2) In FIG. 11, the main magnetic flux passing from the iron core tooth C1 to the iron core tooth C3 and the leakage flux φr1 contributes to the thrust force, and also these magnetic fluxes cause no problem. However, the leakage flux φr2 passing from the commutating pole tooth C2 to the iron core tooth C3 acts in the opposite direction to a thrust force generating mechanism. As a result, these magnetic fluxes increased according to the increase of the drive current I act as a factor of preventing improvement of the generated thrust force (the leakage flux φr2 is increased from the commutating pole teeth C2 in accordance with the increase of the magnetomotive force).

(3) Also, since a height of the commutating pole teeth C2 is the same as a height of the iron core tooth C1, the main portion of the main magnetic flux φ passes from the commutating pole tooth C2 to the inter-tooth permanent magnet 5. In such paths, the main magnetic flux φ passes through the inter-tooth permanent magnet 5 against the magnetization of the inter-tooth permanent magnet 5. Therefore, the magnetomotive force that is larger than that given by the configuration shown in FIG. 7A and FIG. 7B is needed. As a result, an effect of improving the thrust force cannot be achieved by the low magnetomotive force.

In addition, the magnetic attracting force of the inter-tooth permanent magnet magnetic flux φs passing from the iron core tooth C3 to the commutating pole tooth C2 acts in the direction to spoil the thrust force generated by the magnetic attracting force, which is caused by the main magnetic flux φ and the inter-tooth permanent magnet magnetic flux φs passing from the iron core tooth C1 to the iron core tooth C3. Therefore, such magnetic attracting force acts as a factor of preventing the improvement of thrust.

Therefore, the present invention provides a pulse motor having commutating pole teeth that do not act as a factor preventing a generated thrust force.

### MEANS FOR SOLVING THE PROBLEMS

A pulse motor comprises:

a first iron core having a plurality of iron core teeth;

a second iron core having a plurality of iron core teeth, the second iron core being arranged to oppose to the first iron core through an air gap; and

commutating pole teeth formed between the iron core teeth;

wherein a level difference is provided between a tooth tip of the iron core tooth and a tooth tip of the commutating pole tooth.

The pulse motor further comprises:

inter-tooth permanent magnets inserted in space between the commutating pole teeth and the iron core teeth adjacent to the commutating pole teeth respectively;

wherein, when δ2 is a level difference between the tooth tip of the iron core tooth and the tooth tip of the commutating pole tooth, and δ1 is a level difference between the tooth tip of the iron core tooth and the tooth tip of the inter-tooth permanent magnet, respective level differences are provided as ε2>δ1.

In the pulse motor, the commutating pole teeth and the inter-tooth permanent magnets are provided to at least either of the first iron core and the second iron core.

In the pulse motor, the inter-tooth permanent magnets are magnetized in an arranging direction of the iron core teeth of the first iron core or the second iron core, and also are magnetized alternately in an opposite direction in order of arrangement.

In the pulse motor, the inter-tooth permanent magnets are magnetized in such a polarity that main magnetic flux passing through the iron core teeth is prevented from passing through the inter-tooth permanent magnets.

The pulse motor further comprises:

a thrust force characteristic setting portion for substantially changing the level difference between the tooth tip of the iron core tooth and the tooth tip of the commutating pole tooth.

In the pulse motor, the thrust force characteristic setting portion is a commutating pole coil wound on the commutating pole tooth.

In the pulse motor, the thrust force characteristic setting portion is a magnetostrictive material used for forming the commutating pole tooth.

In the pulse motor, the thrust force characteristic setting portion is a piezoelectric device provided with a magnetic material used for forming the commutating pole tooth.

The pulse motor further comprises:

auxiliary inter-tooth permanent magnets which are magnetized in a direction perpendicular to the inter-tooth permanent magnet, the auxiliary inter-tooth permanent magnets being provided at positions where the level difference is provided.

In the pulse motor, the auxiliary inter-tooth permanent magnets are magnetized in such a polarity that main magnetic flux is prevented from passing through the inter-tooth permanent magnets.

### ADVANTAGES OF THE INVENTION

As apparent from the above explanation, following advantages can be achieved by the present invention.

(1) The level difference is provided between the iron core tooth C1 and the commutating pole tooth C20. Therefore, generation of the leakage flux φr2 passing from the commutating pole tooth C20 to the iron core tooth C3 can be avoided, and also a factor of preventing improvement of the generated thrust force according to the increase of the drive current I can be eliminated.

(2) A polarity of the inter-tooth permanent magnet is selected with respect to a polarity of the bias permanent magnet 2 such that the main magnetic flux φ does not pass through the inter-tooth permanent magnet 5. Therefore, the leakage flux φr2 from the commutating pole tooth C20 can be reduced, and the main magnetic flux φ can be focused on the iron core tooth C1. As a result, the effect of improving the thrust force can be obtained from the low magnetomotive force.

(3) An effect of improving the generated thrust force can be obtained from the low magnetomotive force nI. According to this effect, a copper loss of the exciting coil 3 can be suppressed low, and also a power efficiency can be improved.

(4) The level difference between the iron core tooth C1 and the commutating pole tooth C20 can be changed equivalently. Therefore, the generated thrust force characteristic can be changed arbitrarily with respect to the magnetomotive force.

(5) The auxiliary inter-tooth permanent magnets are added. Therefore, the leakage flux from the commutating pole tooth in case of large thrust force and the leakage flux from the inter-tooth permanent magnet in case of the minimum air gap can be suppressed, and also a reduction in the thrust force can be prevented.

### BRIEF DESCRIPTION OF THE DRAWINGS

FIG. 1A is a front sectional view showing a configurative example of a pulse motor to which the present invention is applied, wherein magnetic flux paths are shown when a magnetomotive force is small;

FIG. 1B is a front sectional view showing the configurative example of the pulse motor to which the present invention is applied, wherein the magnetic flux paths are shown when the magnetomotive force is large;

FIG. 2 is an enlarged view of a pair of iron core teeth and commutating pole teeth formed therebetween and inter-tooth permanent magnets inserted in space between the commutating pole teeth and the iron core teeth;

FIG. 3 is a characteristic view showing a relationship between a magnetomotive force nI and a generated thrust force F;

FIG. 4 is a front sectional view showing a pertinent portion of an embodiment in which a level difference between an iron core tooth and a tooth tip of a commutating pole tooth is equivalently changed;

FIG. 5 is a front sectional view showing a pertinent portion of another embodiment in which the level difference between the iron core tooth and the tooth tip of the commutating pole tooth is equivalently changed;

FIG. 6 is a front sectional view showing a pertinent portion of an embodiment in which an auxiliary inter-tooth permanent magnet is provided to the portion where the level difference is provided;

FIG. 7A is a front sectional view showing a configurative example of a related pulse motor, wherein magnetic flux paths are shown when the magnetomotive force is small;

FIG. 7B is a front sectional view showing the configurative example of the related pulse motor, wherein the magnetic flux paths are shown when the magnetomotive force is large;

FIG. 8 is a side sectional view showing the configurative example of the related pulse motor;

FIG. 9 is a characteristic view showing a relationship between the magnetomotive force nI and a magnetic flux density B;

FIG. 10A is a front sectional view showing a configurative example of a related pulse motor disclosed in Patent Document 1, wherein magnetic flux paths are shown when the magnetomotive force is small;

FIG. 10B is a front sectional view showing the configurative example of the related pulse motor disclosed in Patent Document 1, wherein the magnetic flux paths are shown when the magnetomotive force is large; and

FIG. 11 is a front sectional view showing a pertinent portion in FIG. 10B in an enlarged fashion.

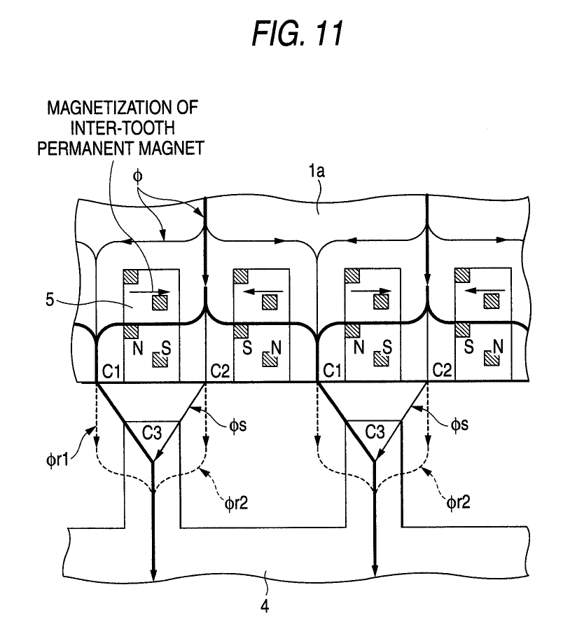

### DESCRIPTION OF REFERENCE NUMERALS AND SIGNS

1a, 1b first iron core

2 bias permanent magnet

3 exciting coil

4 second iron core

5 inter-tooth permanent magnet
C1 iron core tooth (first iron core side)

C20 commutating pole tooth

C3 iron core tooth (second iron core side)

φ main magnetic flux

φc coil magnetic flux

φm bias permanent magnetic flux

φs inter-tooth permanent magnet magnetic flux

φr1, φr2, φr3, φr4 leakage flux

### BEST MODE FOR CARRYING OUT THE INVENTION

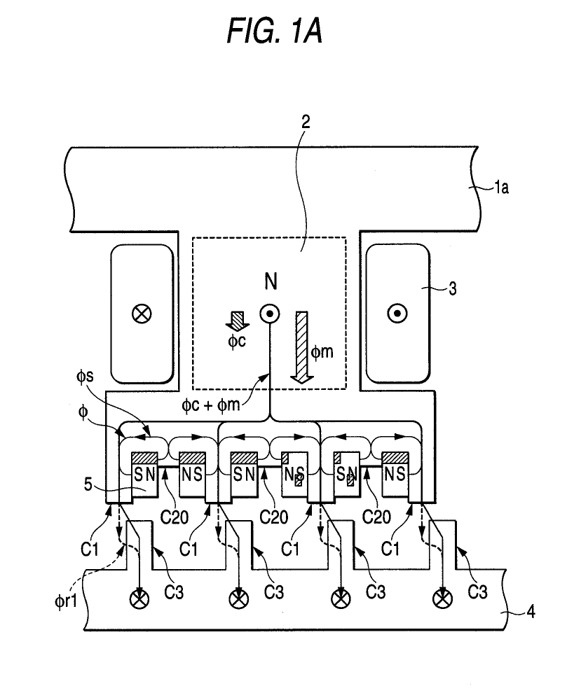

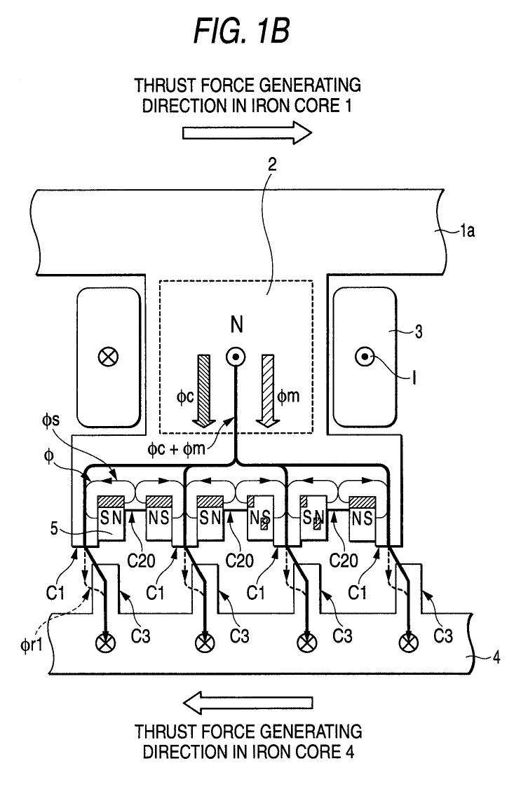

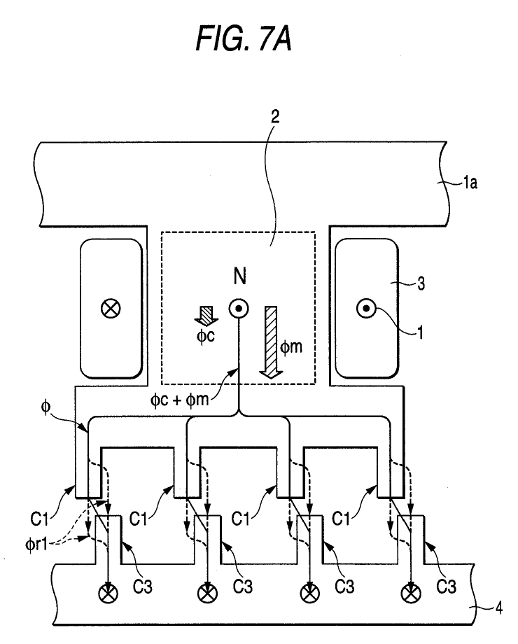

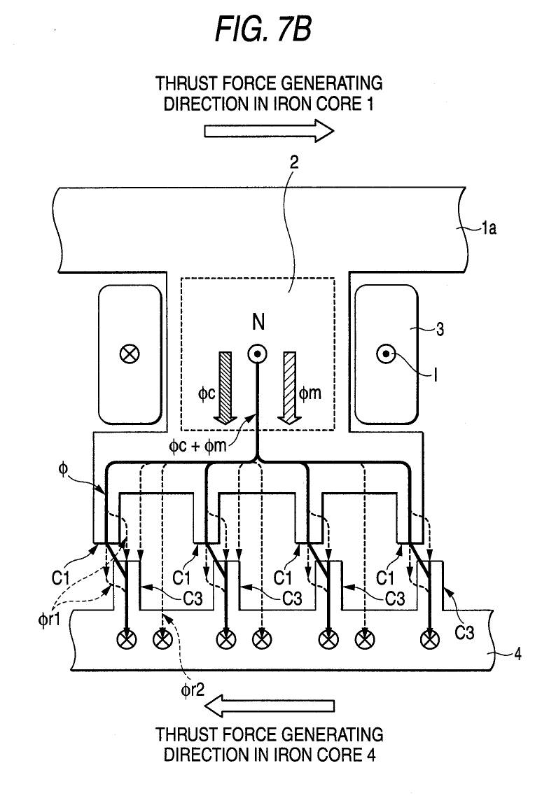

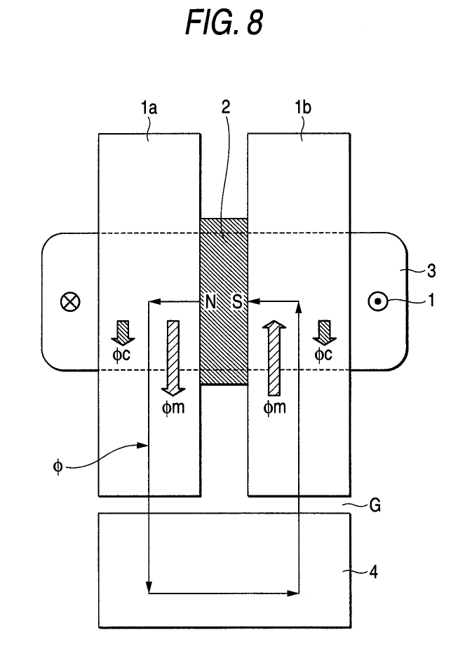

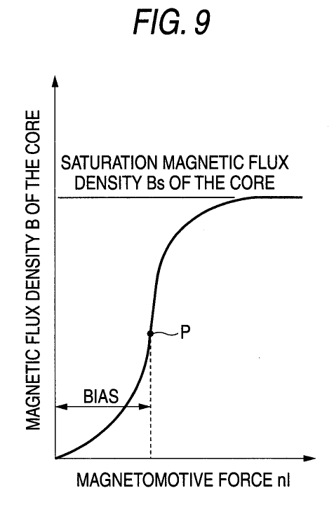

The present invention will be explained in more detail with reference to the drawings hereinafter. FIG. 1 is a front sectional view showing an embodiment of a pulse motor to which the present invention is applied. The same reference symbols are given to the same elements in the configurations explained in FIG. 7A to FIG. 10B, and their explanation will be omitted herein.

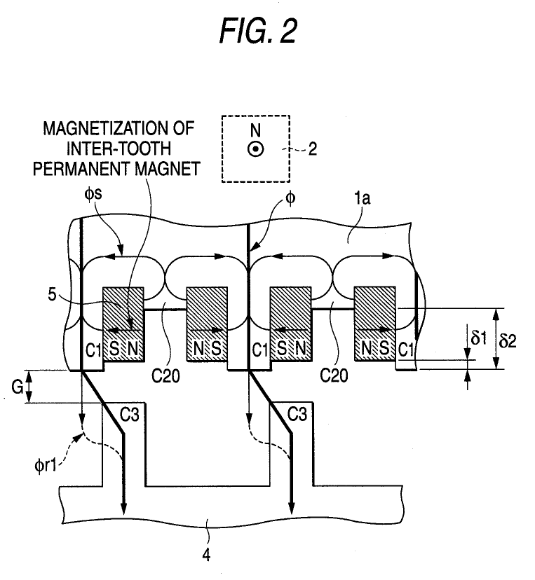

In FIG. 1A and FIG. 1B, a reference numeral C20 denotes a commutating pole tooth formed between the adjacent iron core teeth C1, to which the present invention is applied. FIG. 2 is an enlarged view of a pair of iron core teeth C1 and the commutating pole teeth C20 formed therebetween and the inter-tooth permanent magnets 5 inserted in space between the commutating pole teeth C20 and the iron core teeth C1.

In FIG. 2, δ2 is a level difference formed between the iron core tooth C1 and the commutating pole tooth C20. In this embodiment, a level difference is also formed between the iron core tooth C1 and the inter-tooth permanent magnet 5, and this level difference is indicated by δ1. A relationship between these level differences is set to δ2>δ1.

In this manner, an effect that can be attained by the level difference formed between the iron core tooth C1 and the commutating pole tooth C20 will be explained with reference to FIG. 1A and FIG. 1B.

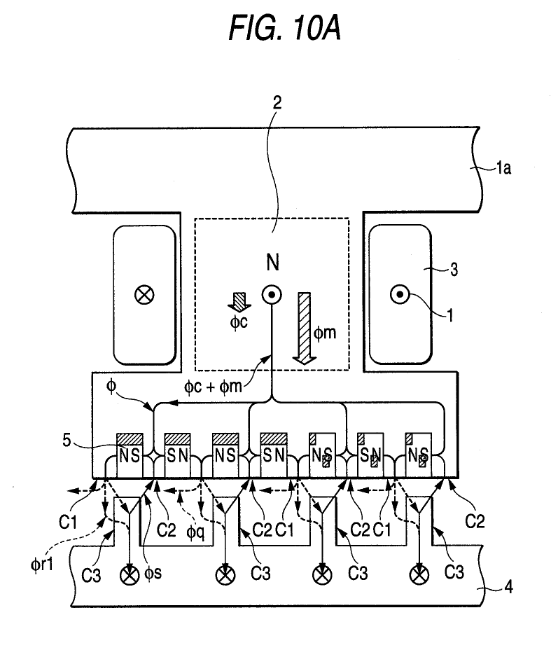

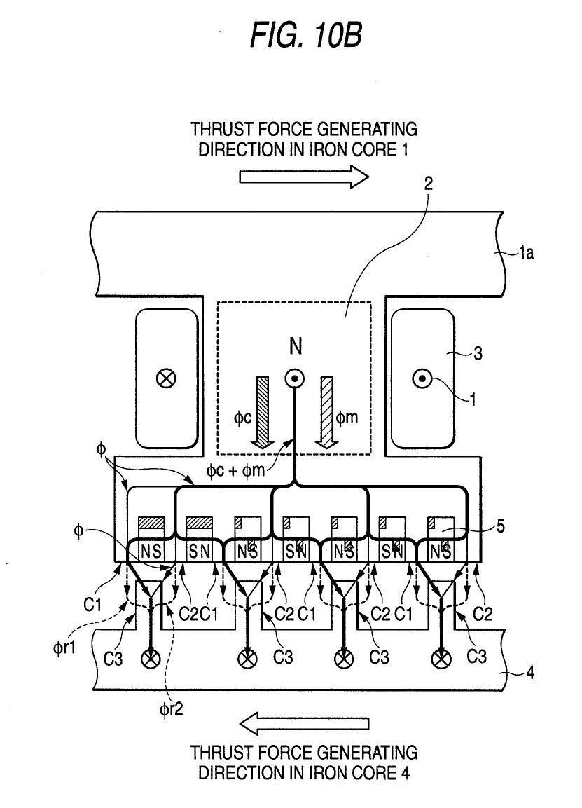

A spatial distance from the commutating pole tooth C20 to the iron core tooth C3 can be set to a distance that is sufficiently larger than the air gap G (δ2>>G). Also, a relationship between the level difference δ2 between the iron core tooth C1 and the commutating pole tooth C20 and the level difference δ1 between the iron core tooth C1 and the inter-tooth permanent magnet 5 be set to δ2>δ1. Therefore, it is possible to avoid a generation of the main magnetic flux φ and the leakage flux φr2 that flow from the commutating pole tooth C2 to the iron core tooth C3, as shown in FIG. 10B, and act as a factor of the magnetic attractive force to spoil the thrust force. As a result, the thrust force can be generated only by the simple main magnetic flux φ flowing from the iron core tooth C1 to the iron core tooth C3.

Because the relationship between the level differences is given as δ2>δ1, the magnetic flux δs of the inter-tooth permanent magnet 5 does not pass through the iron core tooth C3 on the second iron core 4 side via the air gap, like the configuration shown in FIG. 10A, but through only the first iron core 1 side. As a result, the inter-tooth permanent magnet leakage flux φq and the inter-tooth permanent magnet magnetic flux φs both generated in the configuration shown in FIG. 10A can also be blocked.

Then, FIG. 1B showing the paths of the main magnetic flux φ when the drive current I is increased and the magnetomotive force is large is compared with FIG. 1A hereunder. In FIG. 1B, the paths of the main magnetic flux φ passing through the commutating pole tooth C2 to the iron core tooth C3 in the configuration shown in FIG. 10B are never added. Also, similarly to FIG. 1A, the main magnetic flux φ takes the route that comes up to the iron core tooth C3 of the second iron core 4 via the iron core tooth C1 only, and thus the paths of the main magnetic flux φ are not changed at all. Accordingly, the main magnetic flux φ and the leakage flux φr2 that pass through the commutating pole tooth C2 and act as an inhibiting factor in improving the thrust force are not generated essentially.

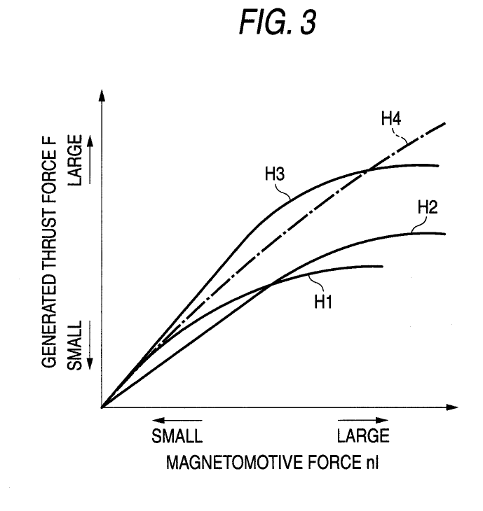

FIG. 3 is a characteristic view showing a relationship between the magnetomotive force nI and the generated thrust force F. In FIG. 3, a characteristic H1 of the configuration shown in FIG. 7A and FIG. 7B, a characteristic H2 of the configuration shown in FIG. 10A and FIG. 10B, and a characteristic H3 of the configuration of the present invention are compared mutually. Because of the effect of reducing the leakage flux from the commutating pole tooth C20, the characteristic H3 of the present invention can achieve improvement of the generated thrust force rather than those of the configurations in the related art while the main magnetic flux φ is approaching saturation magnetic flux densities Bs of the first iron core and the second iron core and after it has come up to the saturation.

As apparent from FIG. 3, according to the configuration of the present invention, the effect of improving the generated thrust force can be obtained from the small magnetomotive force nI. According to this effect, a copper loss of the exciting coil 3 can be suppressed low and a power efficiency can be improved.

This effect can contribute further to the improvement of the generated thrust force when the material having a high saturation magnetic flux density (CoFe-based material, or the like) is employed as the material of the iron core. This high saturation magnetic flux density exceeds the saturation magnetic flux density Bs of the soft magnetic iron sheets (silicon steel sheets, or the like) used in the common motor, or the like.

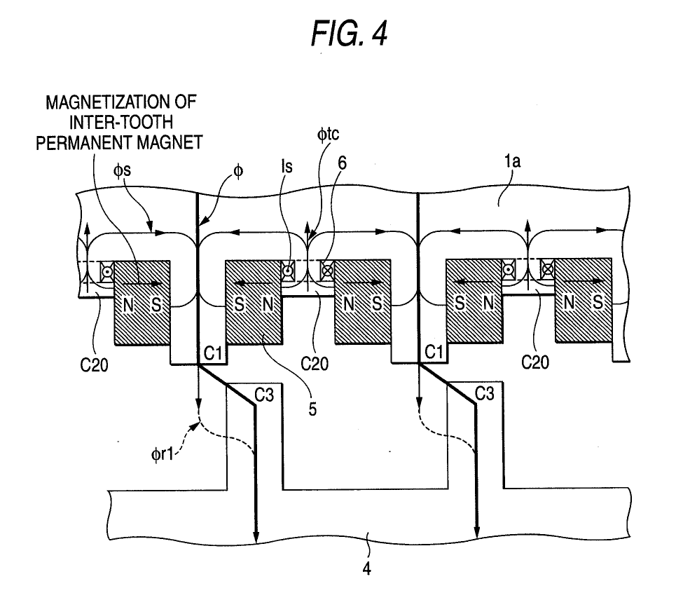

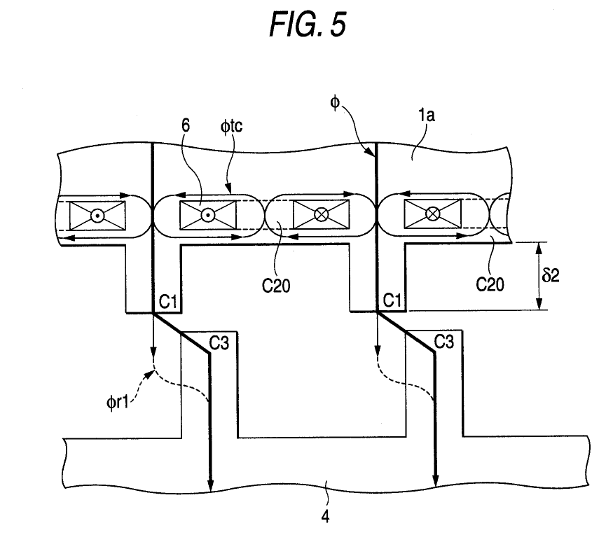

According to the present invention, the generated thrust force characteristic due to the magnetomotive force can be changed by changing equivalently the level difference between the iron core tooth C1 and a tooth tip of the commutating pole tooth C20. FIG. 4 and FIG. 5 are front sectional views showing a pertinent portion of an embodiment in which the level difference is equivalently changed respectively.

In the embodiment in FIG. 4, a polarity of the inter-tooth permanent magnet 5 is selected such that the main magnetic flux φ does not pass through the inter-tooth permanent magnet 5. Also, a commutating pole coil 6 is wound on a root portion of the commutating pole tooth C20, and then a set current Is from a thrust force characteristic setting portion (not shown) is supplied and thus excited.

The generated thrust force characteristic can be controlled, as indicated by a dot-dash line H4 in FIG. 3, by a polarity and an intensity of a commutating pole coil magnetic flux φtc being generated by this excitation. According to this effect, the generated thrust force characteristic can be switched smoothly between the large thrust force characteristic generated by the large magnetomotive force only in accelerating and the high-efficiency characteristic employed in a constant speed operation, like the embodiment shown in FIG. 1A.

Normally the pulse motor having the iron core teeth contains harmonic ripples of the thrust force caused by the cogging torque. The harmonic ripples disturb smooth rotational/linear motions. When the thrust force is generated by the excitation of the commutating pole coil 6 wound on the commutating pole tooth C20 to cancel the ripples in the thrust force, the motor can take the smooth rotational/linear motions. Thus, lower noise and higher efficiency can be achieved.

In the embodiment in FIG. 5, the commutating pole tooth C20 is formed in the inside of the iron core 1 and the commutating pole coil 6 is wound on this commutating pole tooth C20. The generated thrust force characteristic can be controlled, as indicated by the dot-dash line H4 in FIG. 3, by the polarity and the intensity of the commutating pole coil magnetic flux φtc. According to this configuration, the inter-tooth permanent magnet can be omitted.

In order to change equivalently the level difference between the iron core tooth C1 and the commutating pole tooth C20, the commutating pole tooth can be formed by the magnetostrictive material to change a height, or the commutating pole tooth can be formed by the piezoelectric device provided with the magnetic material.

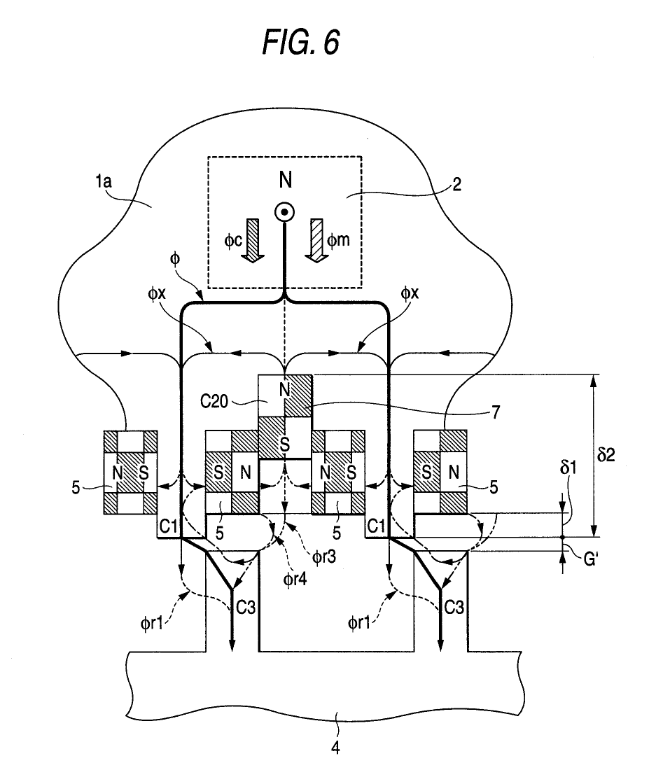

FIG. 6 is a front sectional view showing a pertinent portion of an embodiment in which an auxiliary inter-tooth permanent magnet is provided to the portion where the level difference is provided. In the basic configuration of the present invention shown in FIG. 1, the leakage flux is reduced by causing the magnetic flux generated by the inter-tooth permanent magnet 5 and passed through the commutating pole tooth C20 to compete with the bias permanent magnetic flux φm and the coil magnetic flux φc. Also, the magnetic attracting force and an amount of change with respect to time dφ/dt are maintained even when the magnetic flux density of the iron core tooth C1 reaches around the magnetic saturation. As a result, the improvement of the thrust force can be achieved.

However, in the case where the large drive current I flows through the exciting coil 3 and the coil magnetic flux φc is increased to exceed the magnetomotive force of the inter-tooth permanent magnet 5 when the pulse motor is caused to generate the large thrust force, a leakage flux φ3 indicated by a chain double-dashed line in FIG. 6 is generated from the main magnetic flux φ to the iron core tooth C3 via the commutating pole tooth C20. As a result, an amount of change with respect to time dφ/dt is lowered.

Also, in the case where the iron core teeth C1 and the iron core teeth C3 are opposed mutually by the fluid bearing, or the like to have a minimum air gap length G′ ( 1/10 to 1/100 of the air gap length G), a leakage flux φr4 indicated by a chain double-dashed line in FIG. 6 is generated between the inter-tooth permanent magnet 5 and the iron core teeth C3 because the inter-tooth permanent magnet 5 and the iron core teeth C3 come very close to each other. As a result, an amount of change with respect to time dφ/dt is also lowered.

A reference numeral 7 denotes an auxiliary inter-tooth permanent magnet 7 that suppresses the leakage fluxes φr3 and φr4 generated in the above cases. The auxiliary inter-tooth permanent magnet 7 is arranged such that its magnetization direction intersects orthogonally with the magnetization direction of the inter-tooth permanent magnet 5, in such a mode that the auxiliary inter-tooth permanent magnet 7 is positioned in a portion (tooth-valleys) of the commutating pole tooth C20 used to constitute the level difference and is put between a pair of inter-tooth permanent magnets 5.

An auxiliary inter-tooth permanent magnetic flux φx generated by the auxiliary inter-tooth permanent magnet 7 passes through the inter-tooth permanent magnet 5 and the main magnetic flux φ in the opposite polarity to the bias permanent magnetic flux φm of the bias permanent magnet 2. The leakage fluxes φr3 and φr4 are cancelled by this auxiliary inter-tooth permanent magnetic flux φx, so that a reduction in the thrust force due to a reduction in dφ/dt can be suppressed.

In the embodiment explained as above, the configurative example in which the commutating pole teeth C20 and the inter-tooth permanent magnets 5 are provided on the first iron core 1 side is illustrated. But a configuration in which these members are provided on the second iron core 2 side may be employed, or a configuration in which these members are provided on both sides may be employed. Also, the motion by the generated thrust force F is given relatively. Therefore, it is decided arbitrarily which one of the first iron core 1 and the second iron core 2 should be set to the fixed side or the moving side.

In addition, a position and a width of the commutating pole tooth C20 in the thrust force generating direction with respect to the iron core tooth C1 and iron core tooth C3 can be selected freely in contrast to the pitches of the iron core teeth C1, C3.

This application is based upon Japanese Patent Application (Patent Application No. 2005-143909) filed on May 17, 2005 and Japanese Patent Application (Patent Application No. 2005-323165) filed on Nov. 8, 2005; the contents of which are incorporated herein by reference.

1. A pulse motor comprising:
a first iron core having a plurality of iron core teeth;
a second iron core having a plurality of iron core teeth, the second iron core being arranged to oppose to the first iron core through an air gap; and
commutating pole teeth formed between the iron core teeth;
wherein a level difference is provided between a tooth tip of the iron core tooth and a tooth tip of the commutating pole tooth.

2. The pulse motor according to claim 1, further comprising:
inter-tooth permanent magnets inserted in space between the commutating pole teeth and the iron core teeth adjacent to the commutating pole teeth respectively;
wherein, when δ2 is a level difference between the tooth tip of the iron core tooth and the tooth tip of the commutating pole tooth, and δ1 is a level difference between the tooth tip of the iron core tooth and the tooth tip of the inter-tooth permanent magnet, respective level differences are provided as δ2>δ1.

3. The pulse motor according to claim 2, wherein the commutating pole teeth and the inter-tooth permanent magnets are provided to at least either of the first iron core and the second iron core.

4. The pulse motor according to claim 2, wherein the inter-tooth permanent magnets are magnetized in an arranging direction of the iron core teeth of the first iron core or the second iron core, and also are magnetized alternately in an opposite direction in order of arrangement.

5. The pulse motor according to claim 2, wherein the inter-tooth permanent magnets are magnetized in such a polarity that main magnetic flux passing through the iron core teeth is prevented from passing through the inter-tooth permanent magnets.

6. The pulse motor according to claim 1, further comprising:
a thrust force characteristic setting portion for substantially changing the level difference between the tooth tip of the iron core tooth and the tooth tip of the commutating pole tooth.

7. The pulse motor according to claim 6, wherein the thrust force characteristic setting portion is a commutating pole coil wound on the commutating pole tooth.

8. The pulse motor according to claim 6, wherein the thrust force characteristic setting portion is a magnetostrictive material used for forming the commutating pole tooth.

9. The pulse motor according to claim 6, wherein the thrust force characteristic setting portion is a piezoelectric device provided with a magnetic material used for forming the commutating pole tooth.

10. The pulse motor according to claim 2, further comprising:
auxiliary inter-tooth permanent magnets which are magnetized in a direction perpendicular to the inter-tooth permanent magnet, the auxiliary inter-tooth permanent magnets being provided at positions where the level difference is provided.

11. The pulse motor according to claim 10, wherein the auxiliary inter-tooth permanent magnets are magnetized in such a polarity that main magnetic flux is prevented from passing through the inter-tooth permanent magnets.
